(19) United States
(12) Patent Application Publication
(10) Pub. No.: US 2009/0199242 A1
(43) Pub. Date: Aug. 6, 2009

(54) System and Method for Distributing Video Content via a Packet Based Network

(76) Inventors: Bradley G. Johnson, Brooklyn, NY (US); Simon A. Assaad, Far Hills, NJ (US); David V. Carson, Westport, CT (US); John S. Penberthy, Croton on Hudson, NY (US)

Correspondence Address: CAPITAL LEGAL GROUP, LLC, 1100 River Bay Road, Annapolis, MD, 21409, US

(21) Appl. No.: 12/026,390

(22) Filed: Feb. 5, 2008

(51) Int. Cl. G06F 3/00

(52) U.S. Cl. 725/46

(57) ABSTRACT

A method, product, and system for facilitating the searching of video content from a plurality of different websites is provided. In one embodiment the method includes storing a plurality of videos in a memory, and storing video guide data for a video guide that comprises executable program code that is executable to provide a search input and a content area for displaying descriptive data of a search result. The method further comprises supplying the executable program code to a plurality of clients, receiving a plurality of requests for video guide data originating from the plurality of clients and wherein the plurality of requests are initiated from different web pages of a plurality of different websites. The method further includes, for each request for video guide data, transmitting video guide data to a client originating the request, receiving a plurality of search requests from the plurality of different clients initiated from a video guide; for each search request, performing a search of the plurality of videos based on the search request, and for each search request, transmitting search results to the client originating the search request for display by the video guide. The video guide data may comprise information for configuring the appearance of a variable display element of the video guide, and the method may further include for each request for video guide data identifying the video guide data to be transmitted.

### FIELD OF THE INVENTION

The present invention generally relates to systems and methods for distributing video content via a packet based network, and more particularly to systems and methods for syndicating video content via the internet.

### BACKGROUND OF THE INVENTION

While the Internet has become a widespread means of communicating data, it has recently become a principal means of communicating video data around the world. Most web pages include text, graphics, and other non-video data. However, as broadband has become more ubiquitous, more and more end users are receiving and transmitting video over the Internet. Video files and some audio files tend to be larger than other types of files. The availability of broadband allows users to transmit and receive larger files in acceptable time frames. This fact, at least in part, has led to the increase in the amount of video and audio data communicated over the Internet.

Some web sites that host (store) videos and other content allow users to post video and other types of content for other users to view. Users accessing the host web sites may view content uploaded (posted) by themselves and by other users. In addition, some of these host web sites allow third party web sites to link to videos stored on the host web site. Specifically, code directed to a video (or other content) may be embedded onto the third party's web site to allow visitors to the third party web site to request, receive, and view the video. In other words, an operator of the host server may allow third party web sites to embed code in the web pages of the third party web site. The code may include a link pointing to video content on the host server. Users may visit the third party web site and click on the link to receive the video from the host server or, alternately, the video may be loaded when a third party web site web page is loaded into the client browser. Thus, the user viewing a given web site may receive web pages from the third party web site's server and receive video content from a host server. Accordingly, the video (or other content) is syndicated via third party web sites.

Typically, if a user wishes to search for videos or video channels, the user will need to “visit” the web site of the host that stores the videos to perform the search. More specifically, the user will need to perform a search through the use of a web page that forms part of the web site of the host. The user typically cannot search for videos on the host server from third party web sites (e.g., that syndicate the video).

Consequently, there is a need for technology that allows third party web sites, such as those that syndicate video content, to provide video search functionality of one or more host servers and that allows a host server (i.e., a server that stores videos) to facilitate searches originated from web pages of third party web sites. These and other advantages may be provided by various embodiments of the present invention.

### SUMMARY OF THE INVENTION

The present invention provides a method, product, and system for facilitating the searching of video content from a plurality of different websites. In one embodiment the method includes storing a plurality of videos in a memory, and storing video guide data for a video guide that comprises executable program code that is executable to provide a search input and a content area for displaying descriptive data of a search result. The method further comprises supplying the executable program code to a plurality of clients, receiving a plurality of requests for video guide data originating from the plurality of clients and wherein the plurality of requests are initiated from different web pages of a plurality of different websites. The method further includes, for each request for video guide data, transmitting video guide data to a client originating the request, receiving a plurality of search requests from the plurality of different clients initiated from a video guide; for each search request, performing a search of the plurality of videos based on the search request, and for each search request, transmitting search results to the client originating the search request for display by the video guide. The video guide data may comprise information for configuring the appearance of a variable display element of the video guide, and the method may further include for each request for video guide data identifying the video guide data to be transmitted.

The invention will be better understood by reference to the following detailed description taken in conjunction with the accompanying drawings.

### BRIEF DESCRIPTION OF THE DRAWINGS

The invention is further described in the detailed description that follows, by reference to the noted drawings by way of non-limiting illustrative embodiments of the invention, in which like reference numerals represent similar parts throughout the drawings. As should be understood, however, the invention is not limited to the precise arrangements and instrumentalities shown. In the drawings:

FIG. 1 is a block diagram of an example network environment for distributing syndicated video content according to an example embodiment of the present invention;

FIG. 2 illustrates an example layout of a screen of a video guide for syndicated content according to an example embodiment of the present invention;

FIG. 3 illustrates an example screen of a video guide for presenting results of a search function according to an example embodiment of the present invention;

FIG. 4 illustrates an example screen of a video guide for presenting results of to a history function according to an example embodiment of the present invention;

FIG. 5 illustrates an example screen of a video guide for presenting video results of a content category function according to an example embodiment of the present invention;

FIG. 6 illustrates an example screen of a video guide for showing channel results of a content category function according to an example embodiment of the present invention;

FIG. 7 illustrates an example screen of a video guide for responding to an add to favorites function according to an example embodiment of the present invention;

FIG. 8 is an example screen of a video guide for responding to a favorites function according to an example embodiment of the present invention;

FIG. 9 is an example layout of a video guide for a create new channel function according to an example embodiment of the present invention;

FIG. 10 is an example screen of a video guide for a sign-in function according to an example embodiment of the present invention;

FIG. 11 is an example screen of a video guide showing various tabs for presenting information for a “most popular” category according to an example embodiment of the present invention;

FIG. 12 illustrates an example of a video player and video skin ad according to an example embodiment of the present invention;

FIG. 13 illustrates is an example of an interstitial ad according to an example embodiment of the present invention;

FIG. 14 is a diagram of video guide software executable by a user's computer according to an example embodiment of the present invention; and

FIG. 15 is a flow diagram of a method for syndicating videos via a plurality of publisher web sites according to an example embodiment of the present invention.

### DETAILED DESCRIPTION OF ILLUSTRATIVE EMBODIMENTS

In the following description, for purposes of explanation and not limitation, specific details are set forth, such as particular networks, communication systems, computers, terminals, devices, components, techniques, publication venue, report, web site, data and network protocols, delivery systems, software products and systems, enterprise applications, operating systems, development interfaces, hardware, etc. in order to provide a thorough understanding of the present invention.

However, it will be apparent to one skilled in the art that the present invention may be practiced in other embodiments that depart from these specific details. Detailed descriptions of well-known networks, content delivery services, communication systems, computers, publication venue, report, web site, terminals, devices, components, techniques, data and network protocols, software products and systems, operating systems, development interfaces, and hardware are omitted so as not to obscure the description of the present invention.

A web site, unless otherwise denoted, is meant herein to refer to one or more web pages (e.g., that share a domain name), a blog, ftp lists, directories, and/or other internet form. As used herein, “content” refers to a work which is accessed for presentation by users from web sites. The work may be one or more videos (with or without audio), photographs, graphical images, animations, audio files, textual works, and/or any combination of the same. According to an example embodiment of the present invention, syndicated content comprises content that may be stored on one or more host servers and that is distributed to clients (e.g., browsers) that request such content via web pages served from third party web pages. Finally, “publication venue,” as used herein, is meant to refer to a website or other media (e.g., an email) that provides data files (e.g., web pages) from which a user can request (e.g., via a client) content. As an example, third party websites may serve web pages that include a link to a video or that includes code to request the video when the web page is loaded in the browser.

The present invention allows a plurality of different web sites (third party web sites) to offer their visitors a video guide that allows their visitors to search for videos and video channels that are stored and served by a different host server, create favorites (channels or videos), select and view videos from one of a plurality of categories, view a history of the videos and channels watched by the user, and various other functions. Each video guide may be customized with the logo, background (e.g., colors, images), buttons, borders, forms, and other features of the respective third party web site to thereby appear to form part of the third party web site (e.g., be consistent with the appearance of the third party website). Thus, from the user's perspective unless the user is otherwise informed, the user may experience the video guide and its functions as part of the third party web site. Each video also may be served with a video skin or other video ad type, thereby allowing the third party web site to share in the ad revenues generated by the videos. Unlike some technologies, wherein the user must leave the third party web site to visit the host website to perform searches for videos and channels, the present invention enhances the “stickiness” of the third party website, because the user can perform the searches via the third party web site (i.e., with the appearance of not leaving the third party web site).

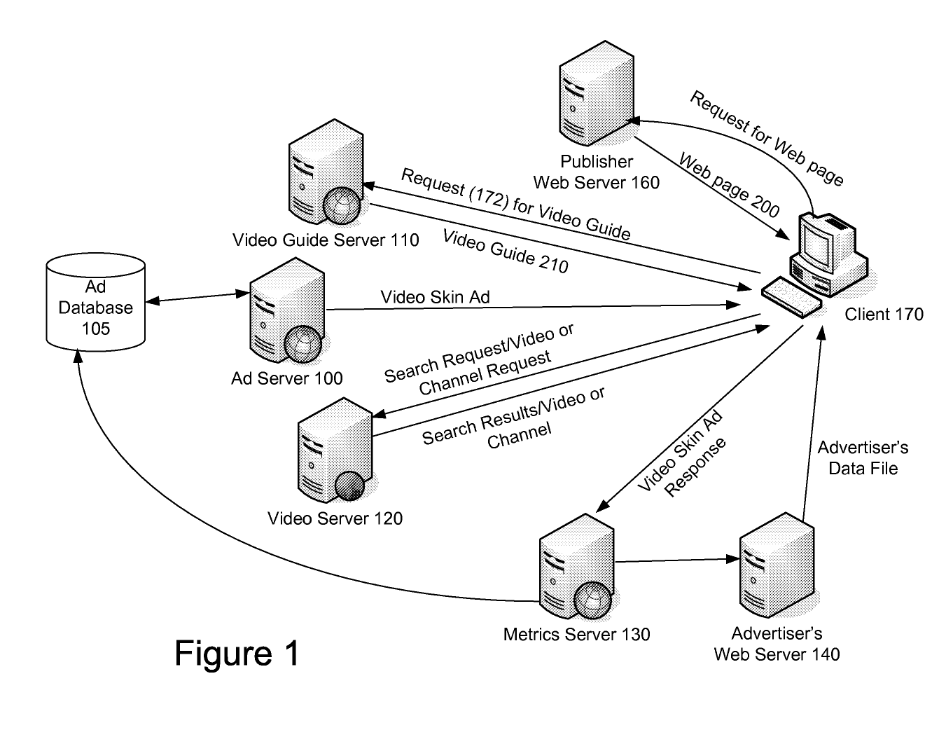

FIG. 1 illustrates the functional components of an environment that may be used to distribute video content according to one example embodiment of the present invention. This example environment includes a third party publisher web server 160, video guide server 110, ad server 100, ad database 105, video server 120, metrics server 130, advertiser's server 140, and the client 170 (e.g., a web browser executing on the end user's computing device). As will be evident to those skilled in the art, in practice there would likely be a plurality of publisher web servers 160, clients 170, and other servers. However for ease of explanation only one of each is illustrated in the figure. In addition, this architecture is one example of an architecture for implementing some embodiments of the present invention and the present invention may be implemented using numerous other architectures.

The servers described herein may include one or more computer systems that each include a processor, memory, a network interface, and executable program code (software) stored in memory that executes to control the operation of the server. Various commercially available computer systems and software may be used to implement the hardware and software. The components of each server may be co-located or distributed. In addition, all or portions of the same software and/or hardware may be used to implement two or more of the functional servers shown. Thus, in some embodiments the components of FIG. 1 may be considered functional components that employ the same hardware and some of the same program code. Other embodiments may include different functional components. In addition, the present invention is not limited to a particular environment or server configuration.

In this example embodiment, the video guide server 110 stores a plurality of video guide data for a plurality of variable display elements that are used to provide a video guide associated with (and customized to appear to form part of) each of a plurality of different third party web sites. Such data may determine the appearance of various display elements such as logos, backgrounds, buttons, borders, categories, initial video, display preferences, initial channels, and other elements. The term “database,” as used herein, is meant to refer to any data structure for storing data whether static or dynamic.

The publisher web server 160 may comprise any web server hosting a website (comprised of one or more web pages 200) that includes a link for requesting the video guide 210 associated with the third party web site. When end users click on a link in one of the web pages 200 (or when such web page 200 is loaded), the client 170 sends a request 172 for the video guide 210 associated with the third party website to the video guide server 110. In response the video guide 210 may be sent to the client, which may appear and execute as if it forms part of the third party's website and is a web page 200 thereof. Alternately, the program code of the video guide may be included in the web page 200 and initiated by the user's click of the link, which results in transmission of a request for the video guide data stored on the video guide server 110 and/or video data to the video server 120. In other words, the software that controls the functionality of the video guide 210 may be received with the web page, but the data for customizing the video guide 210 may be retrieved from the video guide server 110 and/or from data (such as a cookie) stored on the user's computing device when the video guide is started. Data of the variable display elements may be sent to a remote server such as the video guide server 110 (which may respond with the appropriate video guide data (e.g., a logo image)) and/or may be used by the program code of video guide to display the video guide in a manner consistent with the web page of the web site.

The user may make various requests from the video guide, such as to view videos and channels, to search for videos and video channels, to view favorites of the user, to view the user's history of viewed content, and other requests. The requests associated with such selections may be sent to the video server 120 which responds by sending the search results and/or video content back to the client 170.

When the user requests to view a video, a request for an advertisement may be transmitted to an ad server. The ad server 100 may store, select, customize, and transmit advertisements (e.g., images, forms, video, audio, etc.), as well as digital data to the client 170 to be inserted into advertisements and/or video content. Specifically, the ad server 100 may receive a request for advertisements and, in response, select one or more advertisements based on contextual data and transmit the selected advertisements (which may include interactive content). The requests may originate from a publisher's web server 160 (in response to a client 170 requesting a web page) or from a client 170 upon initiation of (or request for) a video from a video guide (e.g., a user clicking on a link to view a video). The ad server 100 may request and receive information from the ad database 105 that may include contextual data, impression data, configurations setting, campaign criteria data, and/or other data for selecting an advertisement. The ad server 100 also may store data in the ad database 105. In addition, the ad server 100 may request and receive digital information (e.g., images, video, audio, etc.) from third party servers (not shown) to be inserted into a video to thereby customize the video or retrieve such digital information from memory. In one example, the ad server 100 receives contextual information from clients 170 and provides one or more contextual advertisement by selecting and/or customizing advertisements based on the contextual information.

The contextual advertisements may be presented in an interactive video “skin” and comprise advertisements that are selected and/or customized based on contextual information such as one or more of geographical information of the end user, demographical information of the end user, personal information about the user, technical information of the end user's computing device (and/or network), information of the video, and/or other data. The advertisement may be selected or customized in any suitable manner such as by, for example purposes only, (1) providing information of venders local to the end user, (2) selecting advertisements that are targeted to the end user's demographics, (3) personalizing the advertisement (e.g., inserting the end user's name or photograph in the advertisement), (4) selecting scenery based on the end user's location or time, (5) sizing and formatting the advertisement according to the user's computing device, and (6) various other customizations. The video may also be customized by inserting a product (i.e., product placement) targeted at the user, the user's demographics, and/or end user's location; personalizing a portion of the video (e.g., inserting a photo of the end user), personalizing text in the video (inserting the user's name on a marquee), and/or inserting audio content of the user in the video, or any other such customization. These selections and customizations are for example purposes only and the present invention is not limited to these examples.

The advertisement may include a form or other input mechanism for receiving information from the end user, which may be used by the ad server 100 or an application executed by the client 170 to provide additional contextual data to the ad server 100. When the user clicks on an ad (or submits a form in the ad), a request is transmitted from the client browser 170 to the advertiser's server 140, directly or indirectly. Actuation (e.g., clicking) of the ad may cause the ad response to be transmitted first to a third party server (e.g., a third party such as DoubleClick®) that provides tracking and other internet metrics for the advertiser. Subsequently, the request may be re-directed to the advertiser's server 140 (or any desired server), which may respond by transmitting the desired data file as shown.

An application on the end user's computing device (e.g., executing in the client), may generate and transmit impression data that includes information of the advertisement(s) that are displayed by the client 170. In addition, other data transmitted may include the date, time, information identifying the webpage or video guide from which the video is requested, information of the domain (e.g., the third party web site serving the web page or video guide), information of the IP address (of the end user's computing device), user information (e.g., the location, address, sex, age, interests, hobbies, web pages previously viewed, domains visited, etc.) and other information such as information sufficient to determine whether a link (or form) associated with the advertisement was actuated. The impression data is received by the metrics server 130, which processes and writes the impression data to the ad database 105.

The video server 120 stores a plurality of videos and, in response to receiving a request, performs a search and transmits the requested data, such as the video content or video channel content, to the requesting client 170. The video player that presents the video at the client 170 may be transmitted from the publisher web server 160 as part of the web page 200, from the ad server 100, from the video guide server 110, or from the video server 120.

In one embodiment, the video guide server 110 and video server 120 are controlled by the same operator, include co-located servers, and may share software. In other words, the video guide (software and functionality) is offered by the operator of the video server 120 (i.e., the host server). In such embodiments, all requests may be sent to a single remote computer system and the user favorites, history, and other user info (e.g., login info) may be maintained by that computer. In another embodiment, the video guide server 110 is operated independently from the video server 120 and may facilitate searches on multiple video servers 120 (i.e., multiple host servers). In such an embodiment, search requests and other data requests may be sent to the video guide server 110 which may translate (perhaps transcode) and transmit (e.g., forward) requests to two or more video servers 120. Results from each video server 120 may be sent to the video guide 210 directly or indirectly through the video guide server 110.

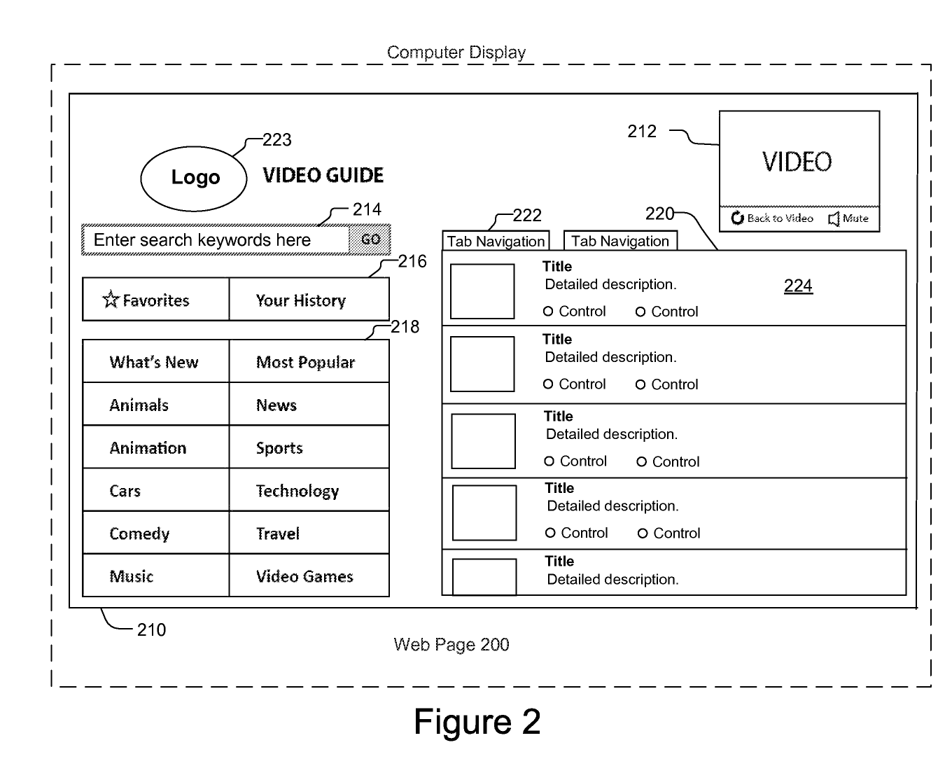

FIG. 2 illustrates a video guide 210 according to an example embodiment of the present invention, which is displayed overlaying the web page 200 that may include the link from which the video guide 210 is requested by the client 170. In other embodiments, the web page 200 is not visible when the video guide 210 is in use. In various embodiments, the video guide may be implemented as a JavaScript, a flash media application, an html file, some combination thereof, or another application vehicle. The video guide may form part of the web page 200 or be separate. In this example, the video guide 210 includes a small video window 212, a search field 214, a favorites and history selection area 216, a content category selection area 218, and a content area 220. In some instances the content area 220 may include navigation tabs 222. As previously described, the video guide 210 may be customized to be consistent with, and appear to form part of, a third party web site. For example, the third party's logo 223 may be displayed. Other customization may be achieved by selecting a display theme (e.g., colors; buttons, border styles, etc.) for a given web site. Customization information for each third party publisher may be stored on the video guide server 110.

The video window 212 allows the user to view a selected video. Various controls may be included, such as play, stop, pause and mute. In some embodiments, rewind and fast forward functions also may be included. Another control allows the user to close the video guide 210 and/or open a larger video player to view a video.

The search field 214 in this example comprises a text box where the user may type in keywords. Upon typing in a keyword, the user may click on a submit button (“Go” in this example) to send the search request to a remote computer, which, depending on the implementation, may be the video server 120, video guide server 110 or other server. In this example, the search is received and processed by the video server 120, which transmits search results that are displayed in the content area 220. Other ways of populating the content area 220 include clicking on the favorites button or history button. Another way of populating the content area 220 is to click on a category listed in the content category selection area 218. Various categories may be listed in area 218. In some embodiments, the categories may be customized for the specific web site. For example, for a third party web site that includes subject matter for extreme sports enthusiasts, the content category selection area 218 may be customized to include video categories likely to be of interest to visitors of the web site such as, for example, extreme skiing, motocross, rock climbing, extreme biking, Warren Miller, etc. The links of 216 and 218 may result in a request sent to the video server 120 when actuated.

For many of the searches, the resulting videos or channels may be listed in the content area 220 in tile format. An example tile format may include a title 224 that includes a thumbnail image, a detailed description and one or more controls. A user may scroll within the content area 220 (via a scroll bar not shown) to view additional tiles 224 when the tiles exceed the viewing window of the content area 220.

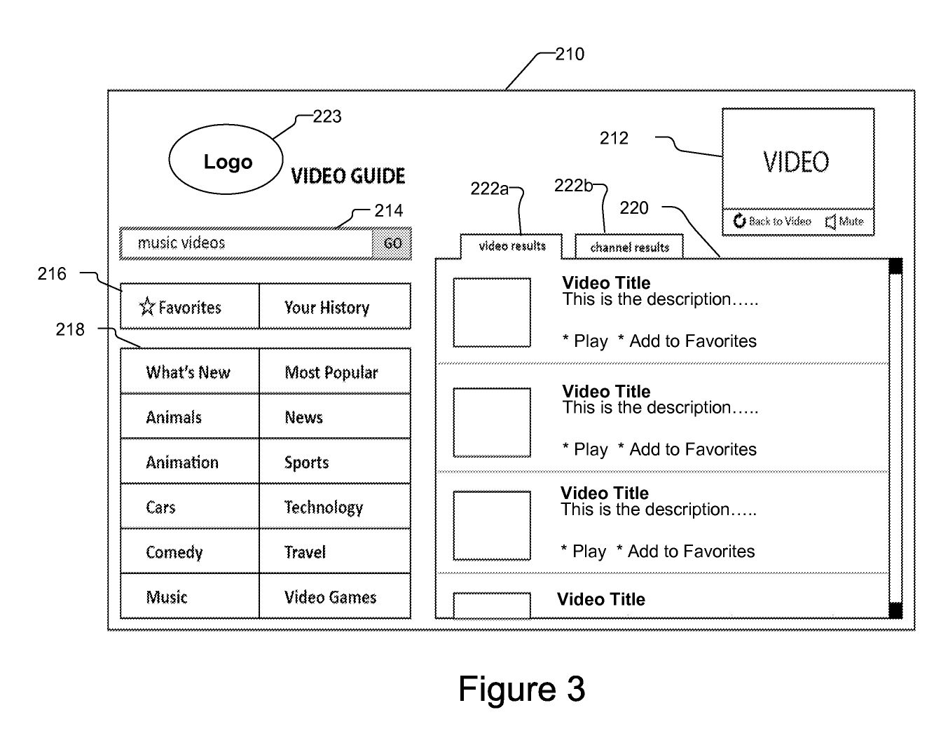

FIGS. 3-11 show various screens of the video guide 210. The layout of the video guide 210 is generally the same for the various screens represented in FIGS. 3-11, including the video window 212, search field 214, favorites/history area 216, content category selection area 218 and content area 220. Note that the content area 220 may change for various functions.

FIG. 3 shows an example screen of a video guide 210 for performing a search. For example, the words “music videos” have been entered in the search field 214 and have been searched. The search results are shown in the content area 220. Note that the search results may be organized into video results and channel results. The video results are accessible via the video results tab 222a. The channel results are accessible via the channel results tab 222b. In an example embodiment the results are displayed as tiles 224, although other formats may be used. Each tile 224 may include the video title (or channel title), a thumbnail image, a detailed description of the video (or channel), and controls. Example controls for a video tile may include “play”, and “add to favorites.” In addition, the video guide server 110 may store data for each third web site that determines the videos and channels that are first presented to a user in the content area 220 (and video window 212) when the video guide 210 is initiated.

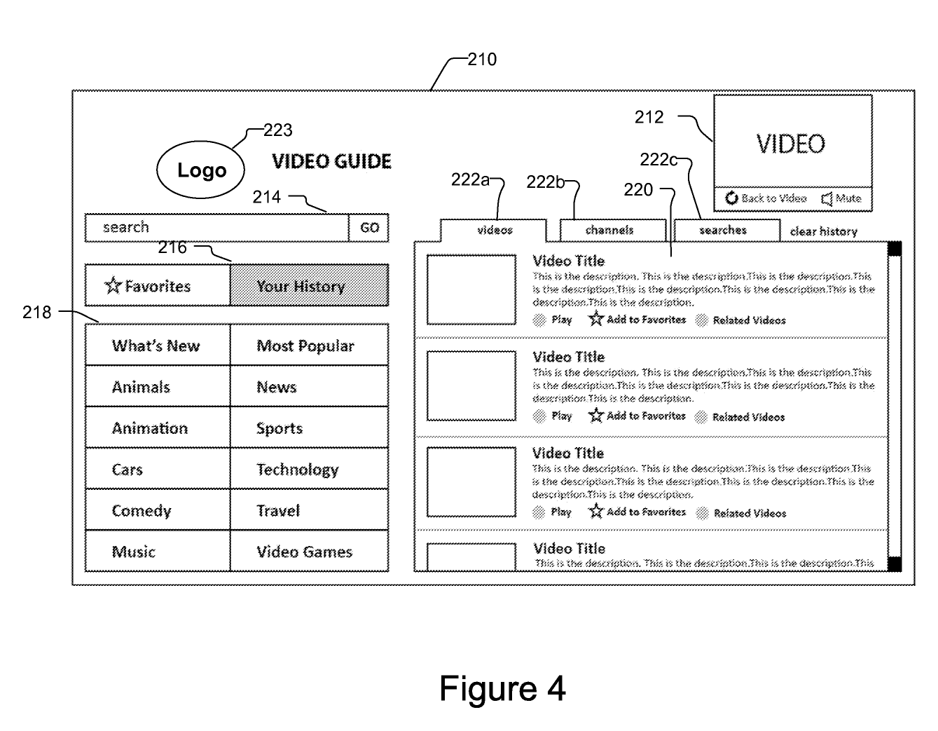

FIG. 4 shows a screen from an example video guide 210 for viewing the user's history. To display the history, the user clicks on the “history” button in the favorites/history selection area 216 causing a request to be sent to a remote computer such as the video server 120, which responds with the requested content. Alternately, data identifying the requested content (or the content itself) may be stored on, and retrieved from, the user's computing device (e.g., in a cookie) and if necessary a request for the identified content may be sent to the video server 120 (after the data identifying the content is retrieved). The history content presented may comprise the recent videos viewed or as the results of recent searches performed. For example, by actuating a first tab 222a, the recent videos may be requested and displayed in the content area 220 in tile format. By actuating the second tab 222b, the recent channels may be requested and displayed in the content area 220. By actuating the third tab 222c, the recent searches may be requested and displayed in the content area 220. A fourth tab, or in this embodiment a button, may actuated to clear the history of the user, which may cause the data stored on the user's computing device or at the server to be deleted.

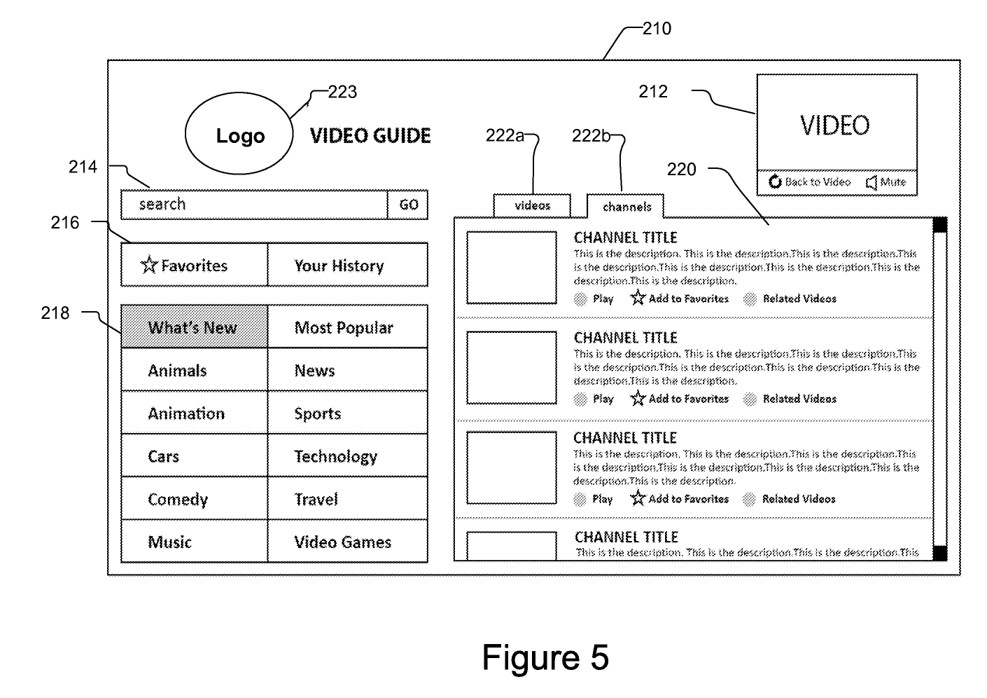

FIG. 5 shows a screen from an example video guide 210 for viewing results of a category selected from the content category selection area 218. In the example illustrated, the user have selected the category “What's New” causing a request to be sent to a remote computer such as the video server 120, which responds with the requested content. The received results are displayed in the content area 220 and may include a listing of channels for that subject matter presented in tile format. As discussed, each tile may include a channel title, a thumbnail image, a channel description and multiple controls. In this example, the controls include “play”, “add to favorites” and “details.” By clicking “play”, videos of the selected channel begin play causing one of the videos for the channel (e.g., the first video; a random video in the channel) to play in the video window 212. By clicking “add to favorites” the channel may be added to the favorites for the user (by adding data to a cookie or by transmitting data of the channel to be added to the user's favorites list to a remote computer for storage). By clicking detail, the detailed content of the channel is displayed.

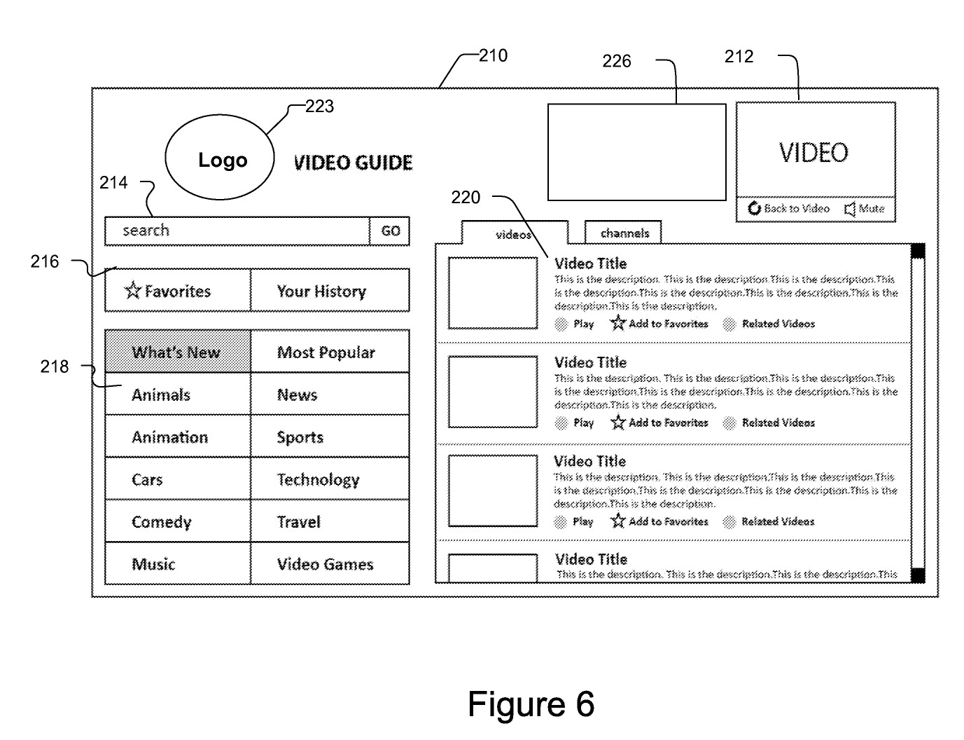

FIG. 6 shows a screen from an example video guide 210 for viewing the detailed channel content. In some embodiments a channel branding area 226 may be included in the video guide 210 when viewing the details of a given channel. The channel branding area 226 may include, for example, graphic content to be associated with the channel. A channel, as used herein, is referred to a group of videos that are related by content or that have been selected by a user, the operator of the system, or other party, to be included in a channel. The channel branding content (e.g., the image) may be served from the video guide server 110 or the video server 120. The content area 220 may include a list of videos that form part of the channel. The detailed channel contents include a tile for each video that includes the video title, a thumbnail image, a detailed description of the video and controls. Example controls may include “play” and “add to favorites.”

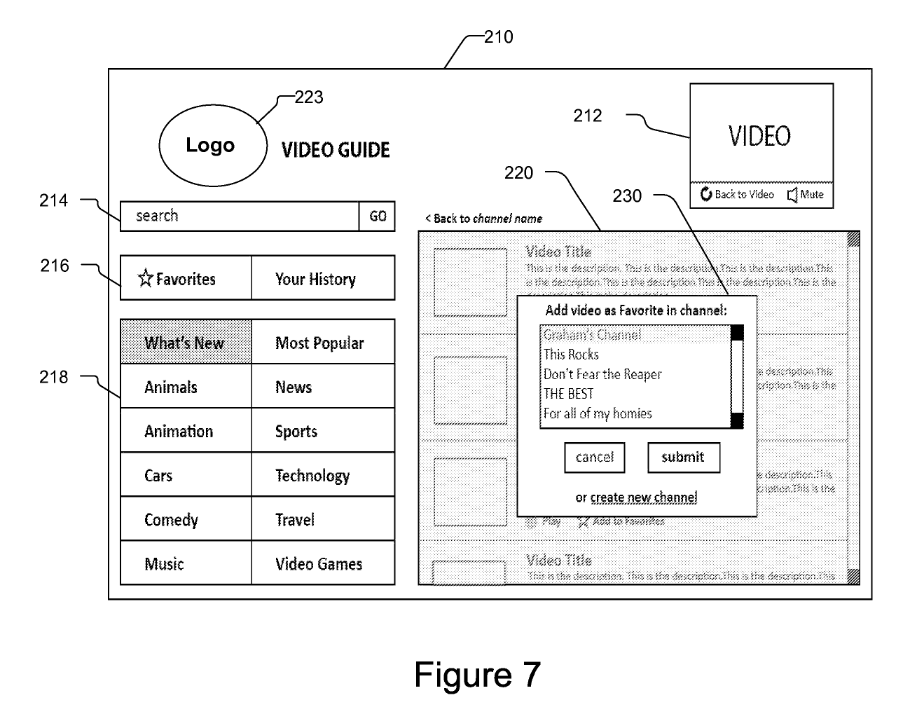

FIG. 7 shows a screen from an example video guide 210 activated in response to a user clicking on the “add to favorites” control of a tile 224. As shown, the content area 220 may include the video list and have an overlay 230. The overlay 230 may include a list of the user's channels. The user may select a channel to which to add the video or create a new channel. The video thereafter will be added to the selected or added channel. In instances where the user views a channel list and selects add to favorites, the channel may be added to the user's list of favorite channels. In the embodiment in which the favorites screen includes a video tab and channel tab, when the user clicks the “add to favorites” button the data may be stored on the user's computer (e.g., a cookie) as a new favorite (either as a new video favorite or channel favorite in accordance with the tab 222 selected) without the need for the overlay 230.

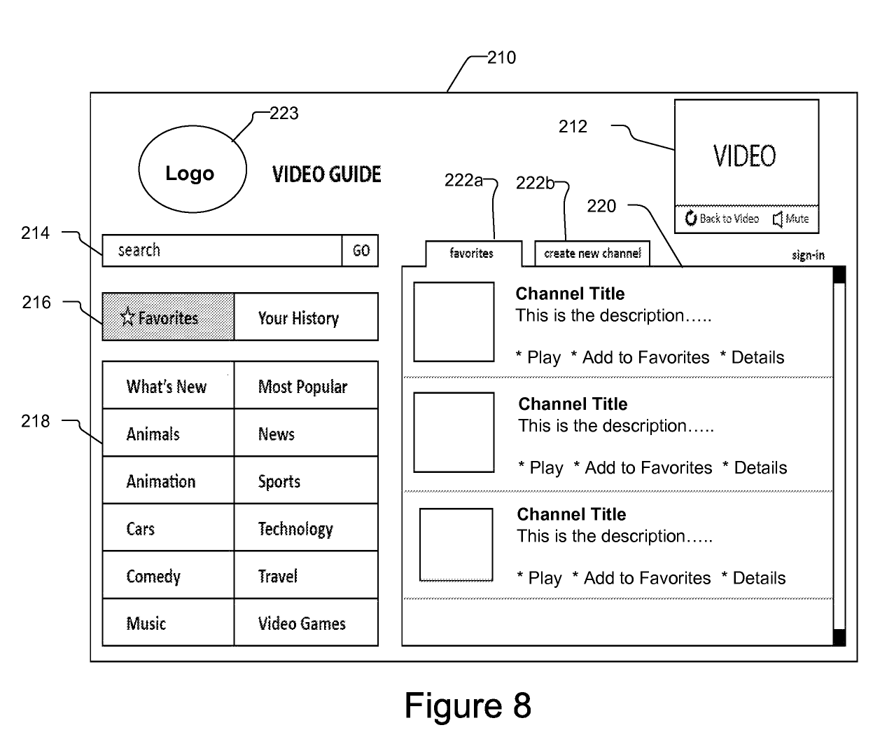

FIG. 8 shows a screen from an example video guide 210 for viewing favorites. In particular, when the user clicks on the favorites button within the favorites/history area 216, a request may be sent to a remote computer such as the video server 120, which responds with the requested content. Alternately, data identifying the requested content (or the content itself) may be stored on, and retrieved from, the user's computing device (e.g., in a cookie) and if necessary a request for the identified content may be sent to the video server 120 (after the data identifying the content is retrieved). The content area 220 displays the received list of favorite channels in tile format. Each tile may include the channel title, a thumbnail image, a channel description and one or more controls. Example controls may include “play”, “details” and “delete”. Clicking “play” may cause a video from the selected channel to be played. Clicking on “details” may cause a listing of the videos comprising the channel to be displayed, such as shown in FIG. 6. Clicking on “delete” may cause the channel to be removed from the favorites list. Such commands on this screen, and elsewhere, may cause data identifying the favorites to be retrieved the user's computing device (e.g., from a cookie) and if necessary a request for the content identified in a file on the user's computer may be sent to the video server 120. For deletion or addition to favorites, information in a cookie, for example, may be changed to add or delete a video or channel to (or from) the user's favorites.

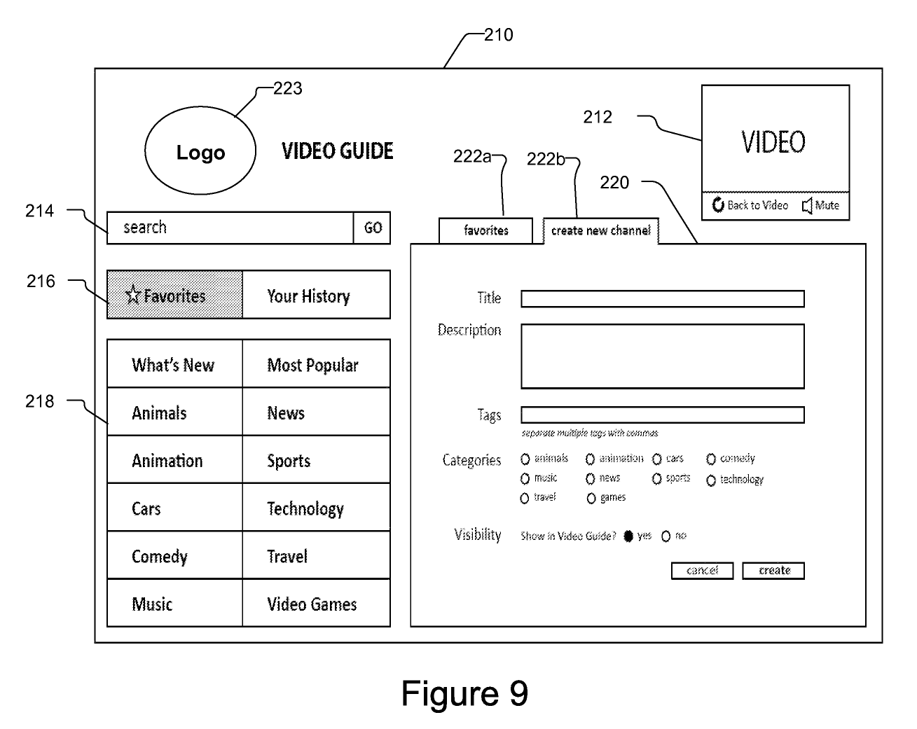

As shown in FIG. 8, the video guide 210 may include multiple tabs 222. Clicking a first tab 222a may cause the listing of the user's favorite channels to be displayed. Clicking on the second tab 222b may activate a form for creating a new channel. In another embodiment, the screen for viewing favorites may include a first tab for viewing videos and a second tab for viewing channels as are illustrated in FIGS. 5 and 5. FIG. 9 shows a screen of an example video guide 210 for creating a new channel. In the example embodiment, the content area 220 may include fields for entering a channel title, a detailed description of the channel, tags, and subject categories to be associated with the channel. The video guide 210 transmits data as part of a request to a remote computer such as the video server 120 for storage. After the user creates a new channel and indicates one or more categories for that channel, the new channel may be returned as part of a search result when users select the appropriate category from the subject category selection area 218. In some embodiments this same screen may appear when double-clicking on a channel tile, so as to allow the information for that channel to be edited.

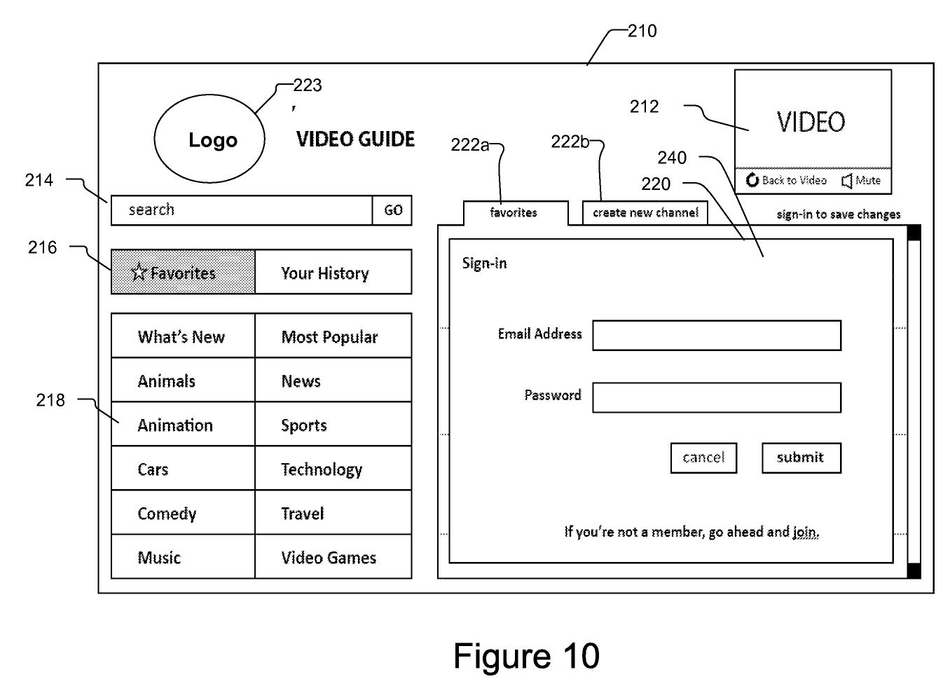

As a way of providing security, the video guide 210 also may include a sign-in feature that is executed before the user may make changes. FIG. 10 shows a screen from an example video guide 210 having a sign-in interface 240 in the content area 220. The sign in interface 240 may appear when select controls are activated such as, for example, delete channel from favorites, add to favorites, create new channel (or edit channel), and others. The content from the sign-in interface 240 may be transmitted to a remote computer, which compares the data with stored data to ensure the identity of the user.

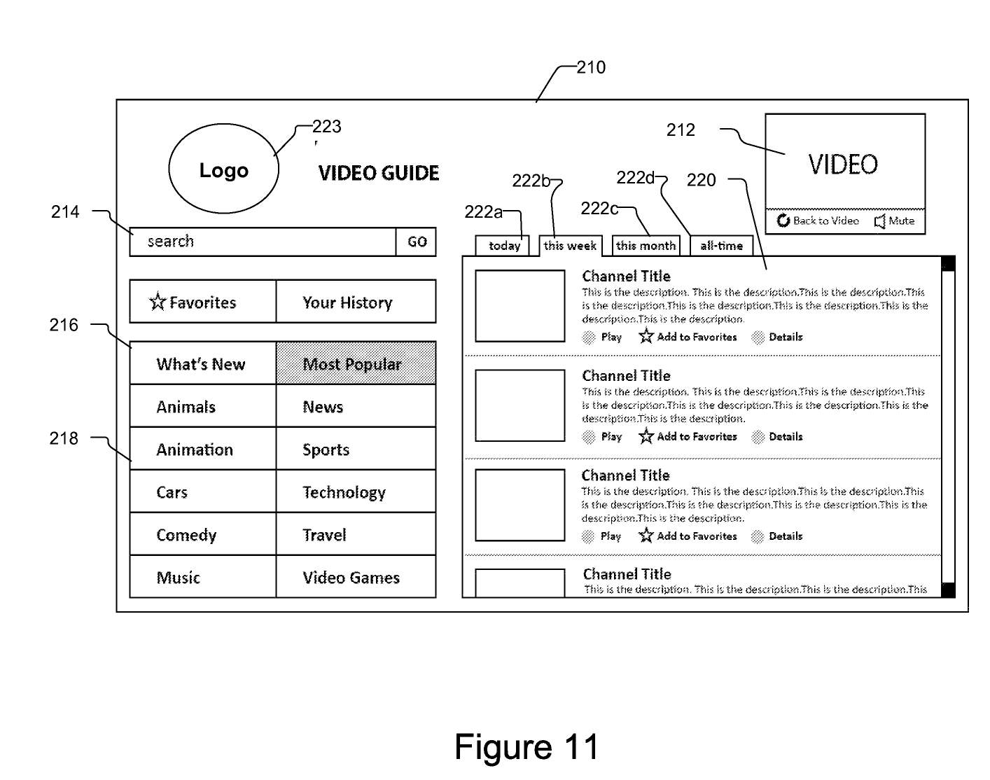

For some screens, the content area 220 may include several tabs 222. In particular the tab names and the number of tabs may vary for the various screens. FIG. 11 shows a screen from an example video guide 210 for the category titled “Most Popular.” This screen may be activated by clicking on the “Most Popular” button in the content category area 218 causing a request to be sent to a remote computer such as the video server 120, which responds with the requested content. In the example screen, results may be presented as the most popular channels for that day, week, month and of all-time. The results may be accessed by clicking on the corresponding tab 222a, 222b, 222c or 222d. The results may be listed in tile format. Each tile may include a channel title, thumbnail image, channel description and one or more controls. Example controls may be as previously described for other channel listings, and include “play,” “add to favorites” and “details.” In another embodiment, the time frame for selection of the most popular is the most recent week and the content area 220 discloses the most popular videos or channels for the week according to the tab 222 selected by the user.

When the “play” control is activated from any of the screens of the video guide 210 listing videos or channels, a video may commence playing in the video window 212. The video window 212 may include a control for switching from a view of the video presented in the video window 212 of the video guide 210 to an enlarged view of the video in a video player. When the control (not shown) is actuated the enlarged video player is displayed. Similarly the enlarged video player may have a button to switch back to the view of the video guide 210, including the video window 212. In another embodiment, when the user selects any video or channel from the content area 220, the enlarged video may be initiated to allow the user to watch the selected video or channel. The user may then actuate the button to view the video in the video window 212.

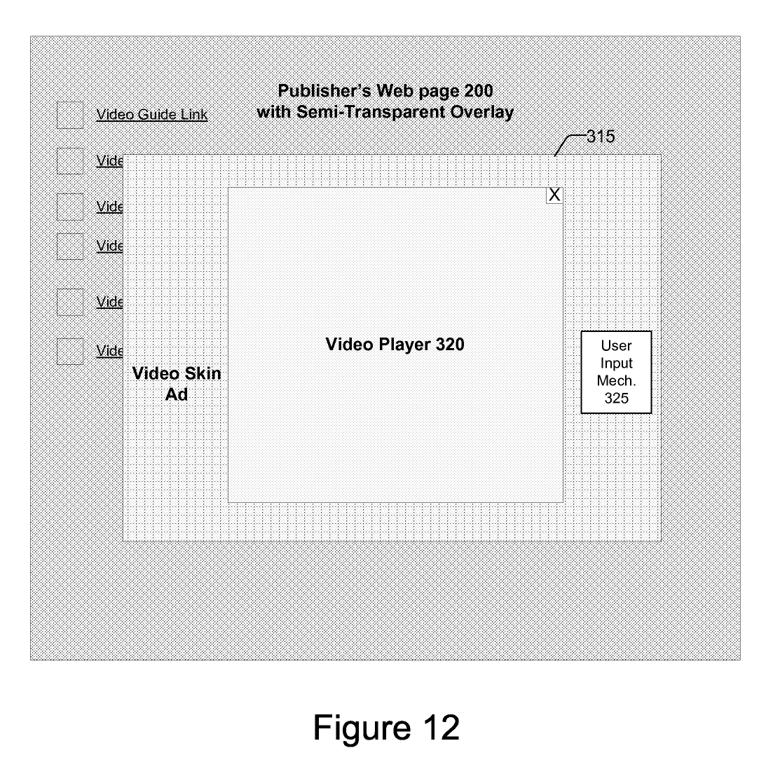

FIG. 12 shows an example display configuration for a video player 320 which may be used in conjunction with the video guide 210 of the present invention. The video player 320 may play video after video in the context of a video channel. The video player 320 may be a javascript or other application, which runs within a browser window (a new window or the existing window).

In an example embodiment the video player 320 may appear over a video skin 315. The video skin 315 may overlay the web page 200 of the third party publisher's web site and over the video guide 210 (not shown). The video player 320 may include a video viewing area, video player controls, and other controls of a conventional video player (as is well-known to those skilled in the art) as well as a link to switch to the video guide 210.

The video skin advertisement may comprise a gif, jpeg or other still image type or a flash or other rich media type, and may include an associated hyperlink (i.e., a click-through URL) and/or form for receiving information from the user and is discussed in more detail below. In this example, the video skin 315 (and ad) extends around the entire perimeter of the video player 320. In other embodiments, the video skin 315 does not extend around the entire perimeter of the video player 320, but instead is adjacent each vertical side of the video player, 320, each horizontal side of the video player, or only one side of the video player 320. The video skin 315 may comprise a piece of embedded code that is entirely independent of the video player 320 (and the video guide 120) and displayed in a separate layer. For example, the video player 320 and the video skin ad 315 may be displayed in the topmost Cascading Style Sheet (CSS) layer of the publisher's web page 200. The user input mechanism 325 of the video skin 315 may comprise any suitable mechanism for obtaining the desired information including, but not limited to, one or more of text fields, text areas, check boxes, radio buttons, and/or drop down lists. The video skin ad may include an associated hyperlink that provides a click through to an advertiser URL so that if the user clicks a portion of the video skin ad, additional content (e.g., a form, a more detailed advertisement or other content) is presented.

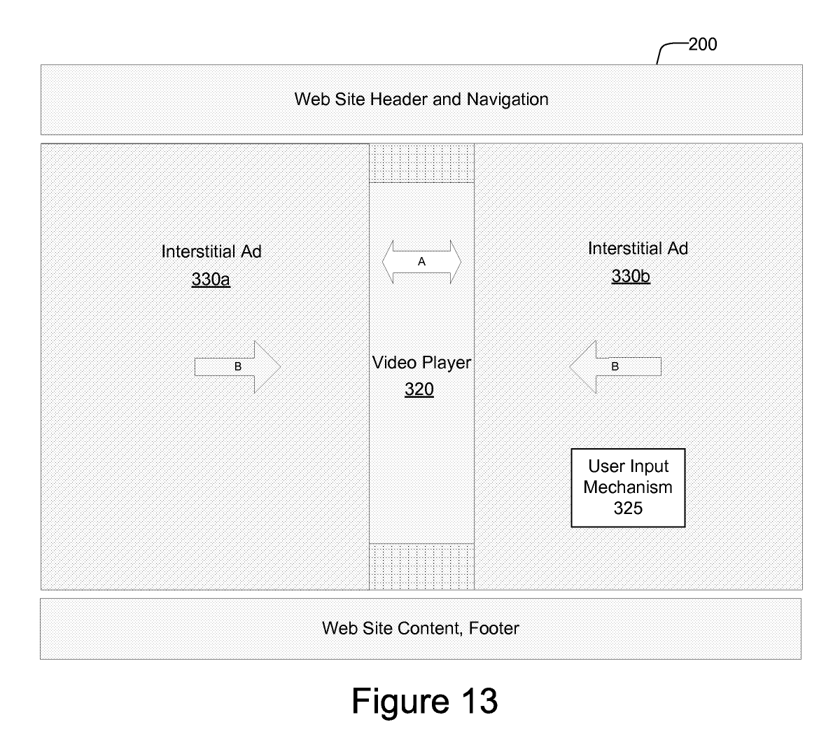

A second type of advertisement that may be presented with video content is an interstitial advertisement that may comprise one or more images (static or video) that are displayed prior to (or after) the video content and that split apart into multiple portions just prior to the beginning of the video content (or come together just after the end of the video content), and may act as a pre-loader while the upcoming video is buffered or transmitted. Referring to FIG. 13, one example interstitial advertisement 330, a jpeg image (although other embodiments may include one or more jpeg, gif, mpg or other files) separates along a vertical line in a manner that is similar to two doors sliding apart to reveal the beginning of the video content. The interstitial advertisement also may include audio content. The arrows in FIG. 13 illustrate the movement of the interstitial ad of one example embodiment. Specifically, the Interstitial ad may comprise a sliding-door style ad that opens (as indicated by arrow A) such as, for example, at the beginning of the video (or prior to presentation) and to reveal the video player and video. When the interstitial ad finishes opening, it may no longer visible in some embodiments (e.g., and, in some embodiments, may open to reveal a video skin ad 315). In addition, when presentation of the video is complete, the doors 330a,b of the interstitial ad 330 may come together to close completely (as indicated by arrows B). The Interstitial ad 330, while wholly visible or partially visible, (either at the beginning or after the video presentation) may provide a click through to an advertiser URL so that if the user clicks on any portion of the interstitial ad the advertiser's content is presented and/or a user input mechanism 325 (e.g., form inputs) to allow the user to supply information.

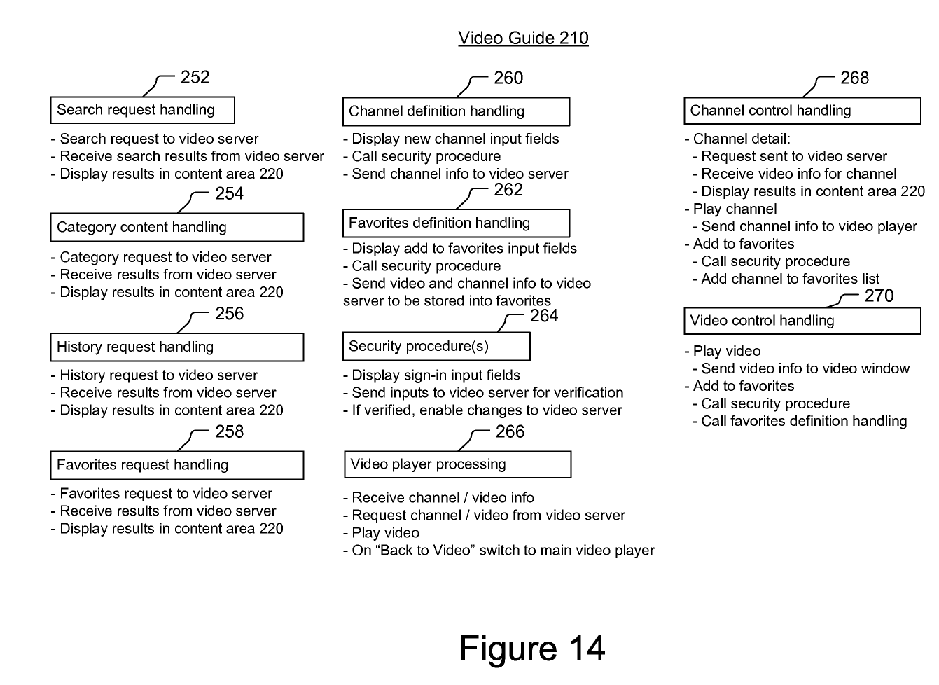

FIG. 14 shows a modular block diagram of executable components of the video guide 210. It is worth noting that that the components illustrated by FIG. 14 and elsewhere are functional components employed herein for ease and clarity of discussion of the processes of one or more example embodiments of the present invention. The different components, in many implementations, may be performed by the same hardware and/or common software modules. In addition, other embodiments may have additional and/or different functional components for performing additional and/or different processes for implementing the present invention. In an example embodiment, the components may be part of a JavaScript (or other application) executed at the client 170. The video guide 210 may include executable code for each of the following functions: search request handling 252, subject category request handling 254, history request handling 256, favorites request handling 258, channel creation handling 260, favorites creation handling 262, security procedures 264, video player 266, channel control handling 268, and video control handling 270.

In the following described embodiment the video guide 210 transmits search requests, favorite requests, history requests, channel requests, and other data requests to the video server 120 and other data requests to the video guide server 110. In other embodiments, the video guide 210 may be configured to transmit requests to a different computer system (e.g., video guide server 110) that communicates with one or more other video servers 120 to provide the requested content. In some embodiments, the user may need to sign-in before the process is initiated or completed such as when adding or deleting a channel or video to or from the user's favorites.

The search request handling module 252 may include code for sending contents of the search field 214 to the video server 120. The video server 120 may execute the search within a database of videos stored on the video server 120. In some embodiments, the search may encompass multiple affiliated or unaffiliated databases on one or more servers. The search results may be sent to the video guide 210 and displayed in the content area 220.

The content category selection handling module 254 may include code for sending category requests to the video server 120. As shown in FIG. 2, the content category selection area 218 may include buttons for various content categories. Clicking on one category may result in a request being sent to the video server 120 to identify the channels and videos in that category (e.g., which may vary per third party website). The video server 120, in turn, may respond by sending the video content for the selected category to the video guide 210 for display in the content area 220.

The history handling module 256 may include code for sending a request to the video server 120 for the user's history. The identity of the user may be established from a cookie or upon log in by the user. The video server 120 may retrieve the history of the identified user from memory. The video server 120, in turn, may respond by sending the channel and video information that comprises the user's history to the video guide 210 for display in the content area 220. If the history data is stored in a cookie, the module may transmit a request to the server 120 for the videos and channels identified in the data file (cookie) stored on the user's computing device.

The favorites handling module 258 may include code for sending a request for the user' favorites to the video server 120. The identity of the user may be established from a cookie or upon log in by the user. The video server 120 may retrieve the favorites for the user from memory. The video server 120, in turn, may respond by sending the channel and video information that comprise the user's favorites to the video guide 210 for display in the content area 220. Alternately, the data may be stored and updated on the user's computing device (e.g. in a cookie). In this instance, the module may transmit a request to the server 120 for the videos and channels identified in the data file (cookie) stored on the user's computing device.

The channel creation handling module 260 may be executed in response to a user clicking on the “create” button for the “create new channel” tab of the favorites information. After completing the new channel information fields and clicking create, the new channel information may be sent to the video server 120 for processing. The video server 120 stores the information and subsequently may supply the channel information to the video guide's of multiple users who wish to view the channel. The channel information may include the tags, categories and visibility field values of the new channel information.

When the securities procedure module 264 is executed, a sign-in interface 240 may appear in the content area 220 of the video guide 210. The user fills in the sign-in information, then clicks “submit.” The sign-in information may be sent to the video guide server 110, which verifies the user. If the user is an authorized user, then the changes to the video guide may be saved in memory of the video server 210 (or stored in a cookie on the user's computer).

The favorites definition handling module 262 may be executed when the user clicks on the “add to favorites” control of a channel list or video list. When selected from a channel list, the channel information may be sent to the video server 120, which stores data in memory to include the channel or video to that user's favorites. Alternately, the data may be stored and updated on the user's computing device (e.g. in a cookie).

The video player processing module 266 may control the video appearing in the video window 212. A user may select to play a video or a channel. Such selection is received by the video player module 266, which in turn may send a request to the video server 120. The video server 120 in turn may send the channel or video content to the video guide 210. The video player module 266 then plays the content in the enlarged video player 320 or the video window 212 (e.g., according to user preferences). The video window 212 also may include a control for switching to the larger video player 320.

The channel control handling module 268 may be run in response to the user selecting one of the controls for a channel tile. In an example embodiment, the channel controls, may include “play”, “detail”, “add to favorites”, and “delete”. When “play” is selected, the video player module 266 is executed as previously described. When “detail” is selected, the video details for a given channel may be displayed in the content area 220. For example, the channel control handling module 268 may send a request to the video server 120 to request the channel details. The video server 120 may respond to the request by sending the channel information to the video guide 210. When the “add to favorites” control is selected, the channel may be added to the favorites, such as by the favorites definition module (which sends a request to the video server 120 that results in modification of the appropriate data in the database of the video server 120). When the “delete” control is selected, the channel may be removed from the user's favorites, through a transmission to the video server 120 that results in modification of the appropriate data in the database of the video server 120. Alternately, data in a cookie may be updated with information of the channel to be added to or deleted from the user's favorites.

The video control handling module 270 may be run in response to the user selecting one of the controls of a tile. In an example embodiment, the video tile may include controls for play and add to favorites. When play is selected, the video player module 266 may be initiated a play the video. When the “add to favorites” control is selected, the favorites definition handling module 262 may be called (which may send a request to the video server 120 that results in modification of the appropriate data in the database of the video server 120). Alternately, data in a cookie may be updated with information of the video to be added to or deleted from the user's favorites.

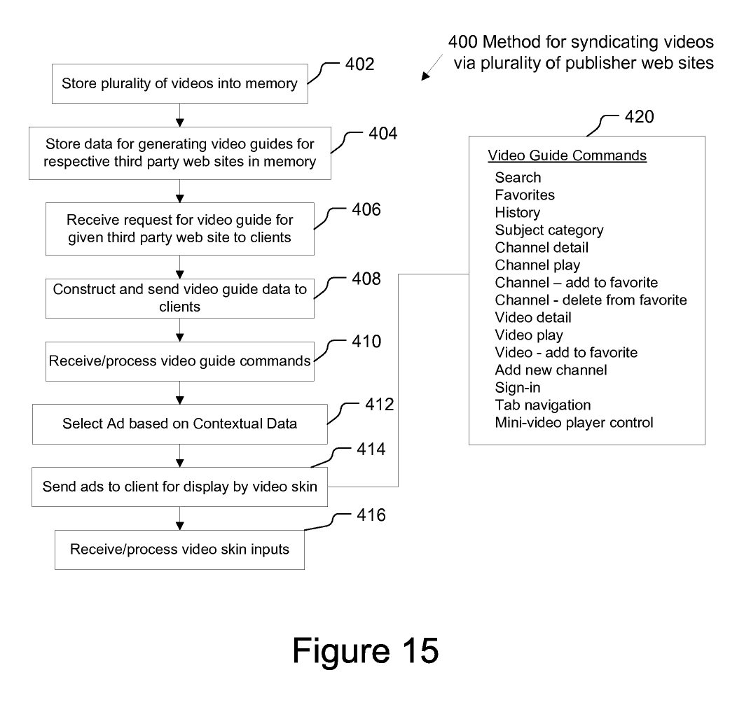

FIG. 15 shows a process flow of a method 400 for syndicating videos among a plurality of publisher's web sites, according to an example embodiment of the present invention. At step 402, videos may be stored in memory, such as at the video server 120. A video title, thumbnail image, and video description may be stored with the video. In some embodiments the video title, thumbnail image and video description may also be stored at the video guide server 110, while the video is stored at the video server 120.

At step 404, data for generating the video guides associated with the plurality of publisher's web sites is stored by the video guide server 110. As discussed, the video guide 210 may be customized for each third party web site. Consequently, logos, images, and data related to the colors, buttons, links, player, tiles, content categories, borders, backgrounds, and other video guide features may be stored in memory of the video guide server 110 for each third party web site. In addition, the video guide server 119 may also store data of a category or maintain a list of videos and channels to populate the video guide 1110 when the video guide is initially substantiated. Thus, the data for constructing each web site's video guide 210 may be stored at the video guide server 110. Some video guide data for a given video guide 210 may be specific to each user, (e.g., favorites, history). Depending on the embodiment, the user specific information may be stored on the video guide server 110 or on the video server 120, and in other embodiments such data may be stored on the user's computing device by the client 170 (e.g., as a cookie). In some embodiments, data for customizing the video guide (e.g., the color or type of button) may be stored in a cookie while other data (e.g., a logo) may be stored on the video guide server 110 (or the third party web site's server 160).

At step 406, the video guide server 110 may receive a request for a video guide 210 associated with a particular third party web site from a client 170. The link for requesting the video guide 210 may include a unique identifier associated with the third party website so that the video guide server 110 can retrieve the appropriate data for constructing (e.g., populating) the video guide 210. For example, the user may click on a link of a web page 200 of the publisher's web site that sends a request for a video guide to the video guide server 110 (e.g., from the client 170.) In another embodiment the program code comprising the video guide may be transmitted to the client as part of the web page 200. At step 408, the video guide server 110 responds to the request by transmitting by constructing (if necessary) the video guide 210 and sending video guide data (images, video data, logos, button data, style data, channel data) associated with unique id in the request to the requesting client. In some embodiments, the video guide data includes information identifying videos and the video guide 210 subsequently sends data requesting the thumbnails, video titles, video descriptions, etc. for populating the content area 220 to the video server, which responds with the data.

At step 410, the video guide 210 may interact with the user when the user clicks on a button, hyperlink or control or otherwise provides a user input. The input may be processed by one of the modules 252-270 (see FIG. 14) of the video guide 210. Box 420 lists several example functions that may be handled by the video guide 210, including: search, favorites, history, subject category, channel detail, channel play, add to channel favorites, delete from channel favorites, video detail, video play, add to video favorites, add new channel, sign-in, tab navigation, video player control, upload video, and others. Execution of many of these functions may include retrieving data from memory of the user's computing device such as a cookie, sending a request to the video guide server 110 and/or the video server 120. The video guide server 110 and video server 120 may respond to the request and send information and content to the video guide 210 as described with regard to the modules 252-270.

One of the commands allows a user to watch a video or channel. When a user requests to watch a video, a request may be sent (e.g., by the client 170, video guide 210, video skin 315 or video player 320) to the ad server 100. At step 412, an advertisement may be selected by the ad server 100 based on contextual data (e.g., the user's location, the video requested, user data, third party's website, etc.) and transmitted (at step 414) for presentation by a video skin 315 at the client 170. Example systems and methods for providing video skins ads (including contextual ads) and interactive content (including advertisements) with video content are provided in U.S. application Ser. No. 11/963,352, filed Dec. 21, 2007, and entitled “System and Method for Providing Interactive Content with Video Content,” which is hereby incorporated by reference in its entirety.

At step 416, the user may interact with the input mechanism 325 and advertisements displayed by the video skin 315. For example, a user may click on an advertisement link and cause the browser to view the advertisement in the browser window, (e.g., the same window; a new browser window; a new browser tab). The user may make inputs to the input mechanism 325 which may be sent to the metrics server 130 and processed as described above.

In one example embodiment, a method of facilitating the searching of video content via a plurality of different websites comprises storing in a memory video guide data for a video guide for each website of the plurality of different websites wherein a video guide includes a search input and a content area for displaying descriptive data of a search result and the video guide further includes one or more variable display elements that are configurable in appearance and wherein the video guide data comprises information for determining the appearance of at least one of the one or more variable display elements. The method further comprises receiving requests for video guide data from a plurality of clients initiated from web pages forming part of the plurality of different websites and for each request, identifying the video guide data to be transmitted and transmitting the identified video guide data to a client originating the request. The search results comprise data of videos and video channels.

The video guide may include a plurality of content category selections and data of the categories of the content category selections may be included in the video guide data for each website. The video guide may comprise executable program code embedded in a web page supplied to each of the plurality of different clients or may be transmitted to each of the plurality of different clients in response to a request.

In another example embodiment, a method of using a computer to provide video content to a user may comprise receiving a first web page forming part of a first website from a web server, receiving a video guide executable program code including one or more variable display elements, executing the video guide program code to display the video guide including the one or more variable display elements configured in appearance to be consistent with the appearance of the first web page and wherein the video guide includes a search input and a content area for displaying descriptive data of a search result. The method may include receiving a search input from the user, transmitting a search request to a second server, receiving search request results; and displaying the search request results in the content area. The method may further comprise receiving a second web page forming part of a second website from a web server, receiving the video guide executable program code including one or more variable display elements, and executing the video guide program code to display the video guide including the one or more variable display elements configured in appearance to be consistent with the appearance of the second web page and not consistent with the appearance of the first web site. The method may further comprises receiving a user input indicating a request for favorites, retrieving favorites data from a memory of the computer, transmitting the favorites data to the second server, receiving favorites content results; and displaying the favorite content results in the content area.

In another example embodiment, the invention comprises a computer program product stored in a tangible computer readable medium and executable by a computer to provide video content to a user. The computer program product may comprise a first code segment configured to display a plurality of actuable content categories and to transmit a category request to a remote computer in response to a user actuation of a content category, a second code segment configured to receive a user input for a search and to transmit a search request to a remote computer in response to the user input, a third code segment configured to display in a content area a listing of videos available for presentation, and wherein the listing includes a thumbnail, title and description of each video. The computer program product may include a plurality of variable display elements that are configurable in appearance to be consistent with a plurality of different websites, wherein the third code segment is configured to display in the content area category results received in response to transmission of a category request, and wherein the third code segment is configured to display in the content area search results content provided in response to transmission of a search request. The category results and search results may comprise video and/or video channel search results in a listing format.

The computer program product may further comprise a fourth code segment configured to receive a request for favorites from a user and to transmit a favorites request to a remote computer in response to the request for favorites from the user. Additionally, the fourth code segment may be configured to retrieve favorites data from a memory of the user's computer and wherein the favorites request includes said favorites data.

It is to be understood that the foregoing illustrative embodiments have been provided merely for the purpose of explanation and are in no way to be construed as limiting of the invention. Words used herein are words of description and illustration, rather than words of limitation. In addition, the advantages and objectives described herein may not be realized by each and every embodiment practicing the present invention. Further, although the invention has been described herein with reference to particular structure, steps and/or embodiments, the invention is not intended to be limited to the particulars disclosed herein. Rather, the invention extends to all functionally equivalent structures, methods and uses, such as are within the scope of the appended claims. Those skilled in the art, having the benefit of the teachings of this specification, may affect numerous modifications thereto and changes may be made without departing from the scope and spirit of the invention.

What is claimed is:

1. A method of facilitating the searching of video content via a plurality of different websites, comprising:
storing in a memory video guide data for a video guide for each website of the plurality of different websites;
wherein a video guide includes a search input and a content area for displaying descriptive data of a search result and the video guide further includes one or more variable display elements that are configurable in appearance;
wherein the video guide data comprises information for determining the appearance of at least one of the one or more variable display elements;
receiving requests for video guide data from a plurality of clients initiated from web pages forming part of the plurality of different websites;
for each request, identifying the video guide data to be transmitted; and
for each request, transmitting the identified video guide data to a client originating the request.

2. The method according to claim 1, further comprising:
receiving a search request from a client initiated from a video guide;
performing a search based on the search request; and
transmitting search results to the client for presentation by the video guide.

3. The method according to claim 2, wherein the search results comprise data of videos and video channels.

4. The method according to claim 1, wherein the one or more variable display elements comprise two or more from the group of: a button display element, a logo display element, and a background color display element.

5. The method according to claim 1, wherein the one or more variable display elements include a logo display element.

6. The method according to claim 1, wherein the video guide includes a plurality of content category selections.

7. The method according to claim 6, wherein data of the categories of the content category selections is included in the video guide data for each website.

8. The method according to claim 1, wherein the video guide comprises executable program code embedded in a web page supplied to each of the plurality of different clients.

9. The method according to claim 1, wherein the video guide comprises executable program code, the method further comprising transmitting the executable program code to each of the plurality of different clients in response to a request.

10. The method according to claim 1, wherein the video guide data for each website comprises information for configuring the appearance of the one or more variable display elements to be consistent with the appearance of the website.

11. A method of facilitating the searching of video content from a plurality of different websites, comprising:
storing a plurality of videos in a memory;
storing in a memory video guide data for a video guide;
wherein the video guide comprises executable program code that is executable to provide a search input and a content area for displaying descriptive data of a search result;
supplying the executable program code to a plurality of clients;
receiving a plurality of requests for video guide data originating from the plurality of clients and wherein the plurality of requests are initiated from different web pages of the plurality of different websites;
for each request for video guide data, transmitting video guide data to a client originating the request;
receiving a plurality of search requests from the plurality of different clients initiated from a video guide;
for each search request, performing a search of the plurality of videos based on the search request; and
for each search request, transmitting search results to the client originating the search request for display by the video guide.

12. The method according to claim 11, wherein the video guide data comprises information for configuring the appearance of a variable display element of the video guide, and the method further comprises for each request for video guide data identifying the video guide data to be transmitted.

13. The method according to claim 12, wherein the video guide includes a plurality of content category selections and data of the categories of the content category selections is included in the video guide data for each of the plurality of websites.

14. The method according to claim 11, wherein the search results comprise data of videos and video channels.

15. The method according to claim 11, wherein the executable program code includes a code segment executable by a user's computer to store data of favorites in memory of the user's computer.

16. A method of using a computer to provide video content to a user, comprising:
receiving a first web page forming part of a first website from a web server;
receiving a video guide executable program code including one or more variable display elements;
executing the video guide program code to display the video guide including the one or more variable display elements configured in appearance to be consistent with the appearance of the first web page;
wherein the video guide includes a search input and a content area for displaying descriptive data of a search result;
receiving a search input from the user;
transmitting a search request to a second server;
receiving search request results; and
displaying the search request results in the content area.

17. The method according to claim 16, further comprising:
receiving a second web page forming part of a second website from a web server;
receiving the video guide executable program code including one or more variable display elements; and
executing the video guide program code to display the video guide including the one or more variable display elements configured in appearance to be consistent with the appearance of the second web page and not consistent with the appearance of the first web site.

18. The method according to claim 16, further comprising:
receiving a user input indicating a request for favorites;
retrieving favorites data from memory of the computer;
transmitting the favorites data to the second server;
receiving favorites content results; and
displaying the favorite content results in the content area.

19. The method according to claim 16, wherein the video guide includes a plurality of actuable content categories, the method further comprising:
receiving a first user input;
in response to the first user input, transmitting a category request to the second server;
receiving category request results; and
displaying the category request results in the content area.

20. The product according to claim 16, wherein at least one of the plurality of variable content elements comprises a logo display element.

21. A computer program product stored in a tangible computer readable medium and executable by a computer to provide video content to a user, comprising:
a first code segment configured to display a plurality of actuable content categories and to transmit a category request to a remote computer in response to a user actuation of a content category;
a second code segment configured to receive a user input for a search and to transmit a search request to a remote computer in response to the user input;
a third code segment configured to display in a content area a listing of videos available for presentation, and wherein the listing includes a thumbnail, title and description of each video;
a plurality of variable display elements that are configurable in appearance to be consistent with a plurality of different websites;
wherein said third code segment is configured to display in the content area category results received in response to transmission of a category request; and
wherein said third code segment is configured to display in the content area search results content provided in response to transmission of a search request.

22. The product according to claim 21, wherein the third code segment is further configured to display in the content area a listing of video channels available for presentation, wherein the listing of video channels includes a thumbnail, title and description of each video channel.

23. The product according to claim 21, wherein the category results and the search results each comprises a listing of videos available for presentation that includes a thumbnail, title and description of each video.

24. The product according to claim 23, wherein the category results and the search results each comprises a listing of video channels available for presentation that includes a thumbnail, title and description of each video channel.

25. The product according to claim 21, further comprising a fourth code segment configured to receive a request for favorites from a user and to transmit a favorites request to a remote computer in response to the request for favorites from the user.

26. The product according to claim 21, wherein the fourth code segment is further configured to retrieve favorites data from a memory and wherein said favorites request includes said favorites data.

27. The product according to claim 21, wherein at least one of the plurality of variable content elements comprises a logo display element.
